(19) United States
(12) Patent Application Publication
(10) Pub. No.: US 2016/0279820 A1
(43) Pub. Date: Sep. 29, 2016

(54) Device for Rotation Punching

(71) Applicants: Wink Stanzwerkzeuge GmbH & CO. KG, Neuenhaus (DE); Rototechnix SAS, Chessy (FR)

(72) Inventor: Joel Boutron, Argent-sur-Sauldre (FR)

(21) Appl. No.: 15/024,037

(22) PCT Filed: Sep. 18, 2014
(86) PCT No.: PCT/EP2014/002527

§ 371 Date: Jun. 15, 2016

(30) Foreign Application Priority Data
Sep. 23, 2013 (DE) 102013110510.6

(51) Int. Cl. B26D 7/26; B26F 1/38

(52) U.S. Cl. CPC B26D 7/265; B26F 1/384

(57) ABSTRACT

The invention relates to a device for rotation punching, comprising a punching cylinder (1), which is rotatable about a punching cylinder axis (2), a counter-pressure cylinder (3), which is rotatable about a counter-pressure cylinder axis (4), wherein the counter-pressure cylinder (3) has raceways (6), on which the punching cylinder (1) or the raceways thereof can run on running surfaces (7), and further comprising an adjusting device, by which the gap dimension between the punching cylinder and the counter-pressure cylinder (1, 3) can be adjusted, and an additional cylinder, the additional cylinder being designed as a support shaft (17), on which the counter-pressure cylinder (3) is directly supported.

The present invention concerns a device for rotation punching, comprising a punching cylinder rotatable about a punching cylinder axis, comprising a counter pressure cylinder rotatable about a counter pressure cylinder axis, wherein the counter pressure cylinder comprises raceways on which the punching cylinder or its punching cylinder raceways can run, as well as comprising an adjusting device by means of which a clearance between punching cylinder and counter pressure cylinder is adjustable, and an additional cylinder.

The subject matter according to the preamble of claim 1 is described in EP 580576 B1. Heat developments as a result of vibration or impacts on the counter pressure roller and mechanical loading in the bearings are dissipated from the raceways exclusively by means of the raceways of the counter pressure roller or by means of the bearings of the counter pressure cylinder. In this context, minimal changes in dimensions of the raceways may occur due to thermal loading of the raceways. These changes can extend into the range of 10⁻⁶ m and therefore can lead to an undesirable change of the clearance. Moreover, the counter pressure cylinder as a result of its hollow cylindrical construction can vibrate strongly wherein the thus resulting forces are absorbed by the bearings which leads to increased wear and potentially a less precise punching pattern. Due to this hollow construction, the stability of the punching device is limited.

It is the object of the present invention to improve an article according to the preamble of claim 1 with regard to the aforementioned disadvantages.

The object is solved by the subject matter according to claim 1. Advantageous embodiments of the invention can be taken from the dependent claims depending on this claim as well as the description.

According to the invention it is provided that the additional cylinder is designed as a support shaft on which the counter pressure cylinder is immediately supported. Support of the counter pressure cylinder is thus not realized by its raceways. Instead, the counter pressure cylinder is resting immediately on the body of the support shaft. The raceways of the counter pressure cylinder therefore do not support it. In this context, the counter pressure cylinder with its metallic surface can be supported on the surface which is also metallic. The support action is however also immediate when both surfaces, or only one surface, comprise a coating, for example.

Possible heat developments in the counter pressure cylinder can thus be transmitted directly onto the support shaft which is preferably embodied as a solid body. Accordingly, the latter can also immediately absorb impacts or vibrations of the counter pressure cylinder. The device moreover is running with significantly reduced vibrations and with reduced wear in the area in which the material to be punched is guided. The system comprising punching cylinder, counter pressure cylinder, and support shaft can be designed to be more stable by means of a solid body construction of the support shaft as well as in particular also of the counter pressure cylinder, at least in its working area.

Accordingly, it is advantageous when the raceways of the counter pressure cylinder are spaced apart from the support shaft and are not running on it. Alternatively, a pressureless rolling of the raceways of the counter pressure cylinder can also be uncritical and can be even advantageous with regard to heat transfer.

In order to carry out an adjustment of the clearance in a device according to the invention irrespective of a support action of the counter pressure cylinder on the support shaft, it is advantageously provided to arrange an eccentric of the adjusting device in a raceway of the counter pressure cylinder. Accordingly, an eccentric is associated with each raceway or bearer ring of the counter pressure cylinder or is supported thereon. By adjusting the eccentric, the raceway of the punching cylinder together with the punching cylinder is then lifted or lowered. In this way, between counter pressure cylinder and punching cylinder a new clearance is provided because the axis of rotation of the counter pressure cylinder remains in its place. A counter pressure cylinder is to be understood in this context as a part of a rotation punching device that is often also referred to as counter punching cylinder. As a result of the inner eccentric, the raceways of the counter pressure cylinder serve thus for lifting or lowering the punching tool or the punching cylinder.

For dissipation of the heat which is produced in the raceways of the counter pressure cylinder and thus also in the eccentrics, they are supported on a solid base body of the counter pressure cylinder, and preferably so as to be free-wheeling, in order to be able to allow for a phase displacement occurring during operation between rotation of the raceways and rotation of the counter pressure cylinder.

According to the invention it can be provided that the outer diameter of the eccentric is embodied eccentrically to the inner diameter of the counter pressure cylinder raceways and is ground in particular, while the inner diameter of the eccentric is supported concentrically on the preferably driven base body. In this way, finer changes of the clearance can be carried out because the height difference can be adjusted across a greater stretch. The drive of the base body or of the counter pressure cylinder is realized in particular by means of gear drives or belt drives and not by friction with the support shaft which is driven in turn.

By the way, whether the punching cylinder comprises raceways that are detachably secured on the remainder of the punching cylinder or whether the punching cylinder is milled from a solid piece and is only provided with running surfaces that can be spaced farther away from the axis of rotation of the punching cylinder in comparison to the working area is an equivalent design for the invention.

Advantageously, in an operating position and after an adjustment of a basic working pressure by a pressing device, a pressure course is provided which is leading from the pressing device via the punching cylinder raceways or the punching cylinder running surfaces, the raceways of the counter pressure cylinder, the eccentrics and the base body (of the counter pressure cylinder) to the support shaft. This is accompanied by the afore described advantages with regard to freedom from vibration and from wear.

Bearings of the punching cylinder are advantageously designed so as to have play in such a way that the variation of the clearance is within the play of the bearing of the stamping cylinder. Therefore, no lose support of the punching cylinder is required; this further increases the precision of the device according to the invention. After adjustment of the clearance and generation of a contact pressure by the pressing device, the punching cylinder is then secured with sufficient precision despite the prior play of the bearing.

Advantageously, the clearance that is adjustable by means of the adjusting device is at least between 1×10⁻⁶ m and 20×10⁻⁵ m, preferably between 1×10⁻⁶ m and 3×10⁻⁵ m. In this way, the usually adjustable clearance values for rotation punching devices can be realized. At the same time, in the present micrometer or 1/100 millimeter range, the available latitude of bearings with play is correspondingly exhausted. For extreme adjustments, it may however be necessary to displace the bearings of the punching cylinder in a guide of a frame of the punching device.

While it may be advantageous that the adjusting device is embodied to be adjustable continuously either manually or by means of a servomotor, the adjusting device in combination with an adjustability carried out by hand or by servomotors can also be provided with an indexing device wherein the indexing steps are advantageously ≦1×10⁻⁶ m. A continuous and in particular self-locking adjusting device can be realized preferably by means of a worm gear drive.

In particular, the support shaft is provided with a solid cylinder body on which the counter pressure cylinder is running. The corresponding heat is distributed here across an area that is as large as possible. Advantageously, the counter pressure cylinder and the support shaft each have contact surfaces at least on the opposite sides toward the raceways. However, the support shaft can also be embodied such that more than two contact surfaces, or a continuous contact surface, relative to the counter pressure cylinder are formed.

A stable configuration of the device is preferably realized when the drive device comprises a gear that is secured on the cylinder body of the support shaft that is particularly embodied as a solid body and transmits torque to the counter pressure cylinder. In this context, preferably the cylinder body of the support shaft itself can be driven by a motor and thus drive the further cylinders. The synchronization of the individual rollers can be realized by means of meshing gears or, for example, by means of a belt drive or a chain of gears of individual shafts synchronized with each other.

Finally, the adjusting device according to the invention ensures that the punching cylinder can be moved relative to the support shaft, the support shaft however relative to the counter pressure cylinder is fixed.

Further advantages and details of the invention can be taken from the following figure description.

In the figures it is schematically illustrated in:

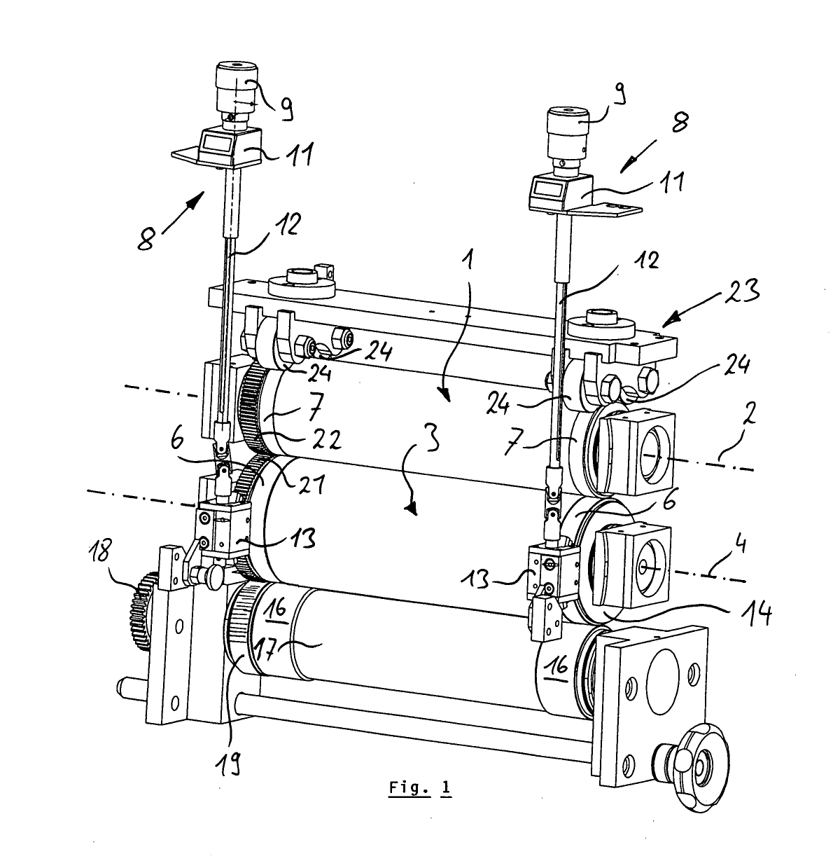

FIG. 1 a perspective view of a device according to the invention;

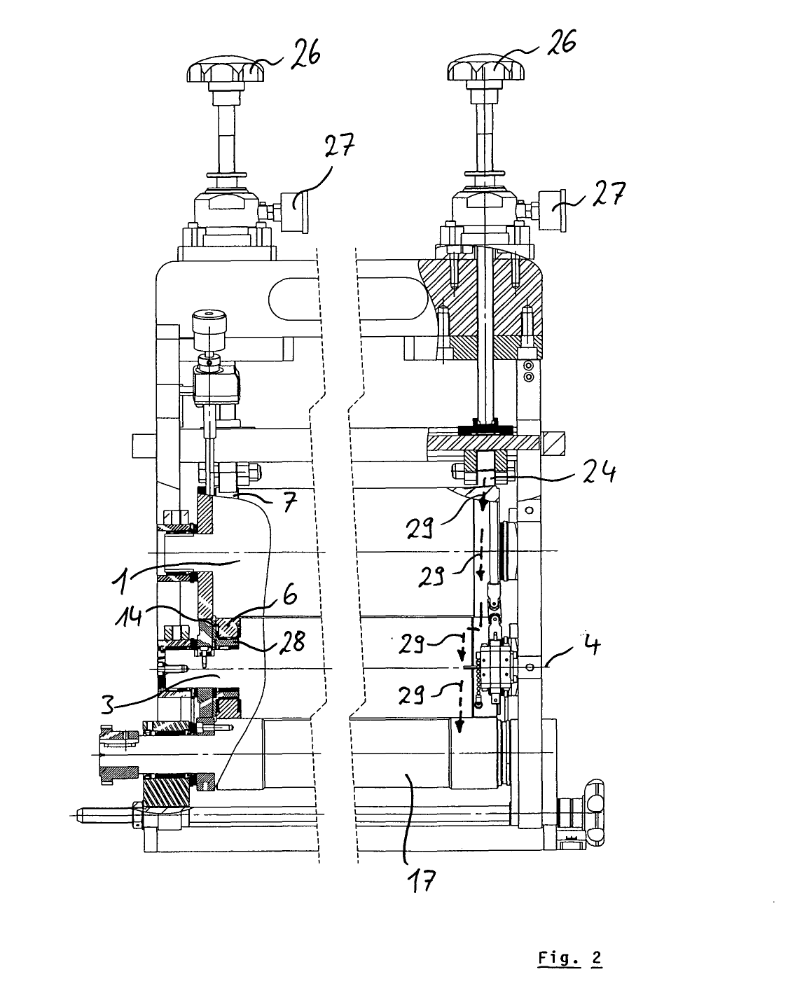

FIG. 2 a partially broken away view of a device according to the invention;

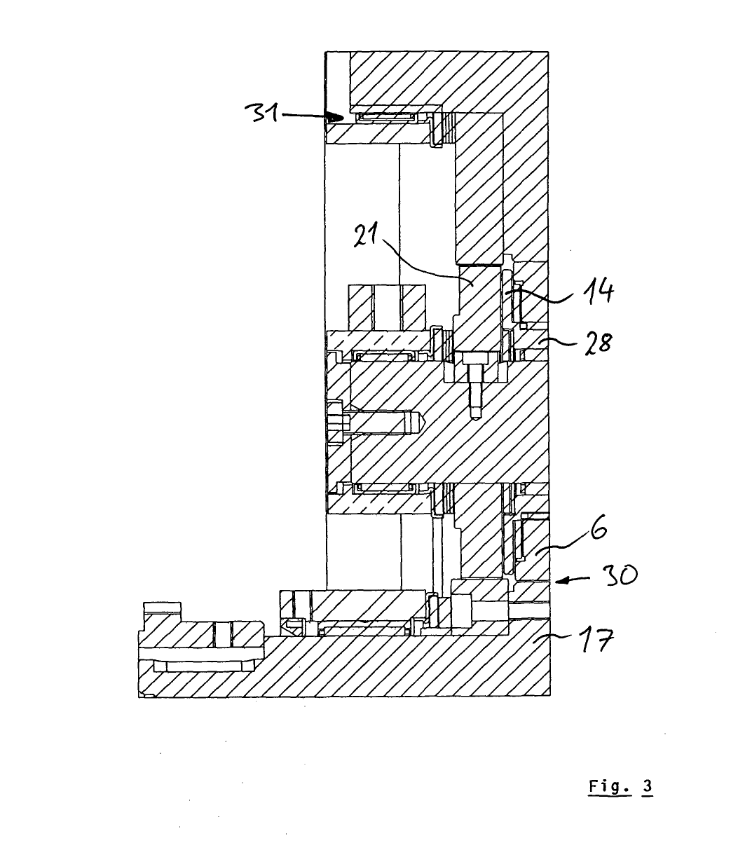

FIG. 3 a detail view of the object of FIG. 1.

Individual technical features of the embodiments described in the following can also be combined to objects according to the invention in combination with embodiments described above as well as the features of the independent claims and possible further claims.

A device according to the invention for rotation punching according to FIG. 1 is provided with a punching cylinder 1 which is arranged to be rotatable about a punching cylinder axis 2. Moreover, the device comprises a counter pressure cylinder 3 which is rotatable about a counter pressure cylinder axis 4. The counter pressure cylinder 3 comprises raceways 6 on which running surfaces 7 of the punching cylinder 1 are running. These running surfaces 7 can either be part of punching cylinder raceways that are separately manufactured or can be designed monolithic together with the punching cylinder body. Moreover, the rotation punching device comprises an adjusting device by means of which the clearance between the punching cylinder 1 and the counter pressure cylinder 3 is adjustable. By means of the clearance the depth of the punching process is adjustable in the end.

The adjusting device for adjusting the clearance comprises two operating units 8 by means of which separately on both sides an associated eccentric is adjustable. In this way, the two axes of rotation 2 and 4 can also be positioned at a slant to each other, for example, in order to compensate a one-sided wear during a punching process. The adjustment can also be realized during operation; access to the eccentric is possible also during rolling and running of the rollers/cylinders. The operating units 8, which alternatively can also be controlled by servomotors, linked with each other and operated by means of a common electronic operating unit, comprise in the present case manually actuatable (clearance) adjusting means 9 as well as display units 11 by means of which the spacing or the clearance on each side can be displayed. In the end, by means of the adjusting means 9 a shaft 12 is actuated, respectively, which by means of a worm gear drive in a housing 13 can access an adjusting disk 14 which is correlated with the eccentric and usually monolithically connected therewith. By pivoting this disk 14 about the axis 4, the raceways 6 are moved with their outer surfaces relative (radially) to the axis of rotation 4 and accordingly displaced for changing the clearance while the counter pressure cylinder remains in position with its axis of rotation 4. The raceways 6 of the counter pressure cylinder are thus arranged so as to be positionally changeable relative to the counter pressure cylinder 3 by means of the respective eccentric and the adjusting device.

The counter pressure cylinder 3 is configured at least in its working area as a solid cylinder so that the counter pressure cylinder 3 or its solid base body can run immediately on the contact surface 16 of the support roller 17. The support roller 17 that is at the same time also the drive shaft, is configured in the area of the running surfaces or contact surfaces 16 also as a solid body and can therefore effectively absorb impacts that are acting on the counter pressure cylinder and dissipate generated heat.

The rotation punching device is driven by motoric means, not illustrated, wherein a drive gear 18 transmits torque onto the support shaft 17 from where, by means of a gear 19 fixedly connected thereto, it is transmitted to further gears 21 (counter pressure cylinder 3) and 22 (punching cylinder 1).

Not shown is a frame of the rotation punching device in which the respective cylinders and shafts are arranged and by means of which, by means of a pressing device 23 that is only partially shown, a contact pressure can be applied. This contact pressure is further transmitted via the running surfaces 7 to the raceways 6 and by means of its bearings to the solid body of the punching cylinder and then from there to the support shaft 17.

The pressing device 23 comprises at the respective opposite ends of the punching cylinder 1 two pressing rollers 24, respectively, that are pushing on the running surfaces 7.

The pressing device is illustrated in more detail in FIG. 2 wherein, in turn, also adjusting means 26 and display means 27 serve for controlling the contact pressure.

According to the further embodiment of the invention illustrated in FIG. 2, the punching cylinder 1 is embodied substantially as a solid body so that the running surfaces 7 are produced monolithically together with the punching cylinder and not as parts of raceways attached to the solid body of the punching cylinder, as it may be possible in further embodiments of the invention.

An eccentric 28 of the adjusting device is arranged inside the raceways 6 wherein “inside” means a direction toward the counter pressure axis of rotation 4. The raceway 6 is supported by bearings, in the present case by means of roller bearings, on the eccentric 28. The eccentric 28 itself is supported, in turn, on the base body of the counter pressure cylinder. By means of actuation of the adjusting disk 14 (compare FIG. 3) in the illustrated figure plane a displacement of the punching cylinder 1 in upward or downward direction is carried out.

Arrows 29 which are illustrated in dashed lines show the course of the pressure beginning at the pressing device 23 in direction toward the support shaft 17. Since the drive action and the synchronization of the cylinders is realized by means of gears or belt or chain drives and not by means of a friction-controlled drive action as a result of the connection of the support shaft 17 with the base body of the counter pressure cylinder 3, the drive action of the device is realized without any influence by possibly occurring impacts and vibrations acting on the cylinders and shafts. The punching result is thus improved.

In the detail view according to FIG. 3, the broken away area with the eccentric 28 shown in FIG. 2 is here illustrated again in more detail. It can be seen that the actuation by means of the adjusting disk 14 of the eccentric 28 is independent of the gear 21. It is also apparent that between the running surface of the raceway 6 and the support shaft 17 in the area 30 a gap is existing, i.e., the raceway 6 is not running on the support shaft 17. Bearings 31 of the punching cylinder are provided with sufficient play in order to be able to realize the described changes of the clearance between punching cylinder 1 and counter pressure cylinder 3.

What is claimed is:

1.-12. (canceled)

13. A device for rotation punching, comprising:
a punching cylinder rotatable about a punching cylinder axis;
a counter pressure cylinder rotatable about a counter pressure cylinder axis;
the counter pressure cylinder comprising raceways;
the punching cylinder comprising running surfaces that are disposed on the raceways of the counter pressure cylinder and configured to run on the raceways of the counter pressure cylinder;
an adjusting device configured to adjust a clearance between the punching cylinder and the counter pressure cylinder;
an additional cylinder configured as a support shaft;
the counter pressure cylinder supported immediately on the support shaft.

14. The device according to claim 13, wherein the running surfaces are provided on a punching cylinder body of the punching cylinder or on raceways of the punching cylinder.

15. The device according to claim 13, wherein the raceways of the counter pressure cylinder are spaced apart from the support shaft.

16. The device according to claim 13, wherein the adjusting device comprises an eccentric arranged in one of the raceways of the counter pressure cylinder.

17. The device according to claim 16, wherein the eccentric is supported on a solid base body of the counter pressure cylinder.

18. The device according to claim 17, wherein the eccentric is supported on the solid base body so as to be free-wheeling.

19. The device according to claim 17, wherein an outer diameter of the eccentric is eccentrically embodied relative to an inner diameter of said one raceway in which said eccentric is arranged and an inner diameter of the eccentric is supported concentrically on the solid base body.

20. The device according to claim 19, wherein the outer diameter is eccentrically ground relative to the inner diameter of said one raceway in which said eccentric is arranged.

21. The device according to claim 17, further comprising a pressing device configured to adjust a basic working pressure, wherein, in an operating position and after adjustment of the basic working pressure, a pressure course extends from the pressing device via the running surfaces, the raceways of the counter pressure cylinder, the eccentric, and the solid base body to the support shaft.

22. The device according to claim 13, wherein the punching cylinder comprises bearings that are provided with play in such a way that a variation of the clearance is within the play of the bearings.

23. The device according to claim 13, wherein the clearance is adjustable in a range between 1×10⁻⁶ m and 20×10⁻⁵ m.

24. The device according to claim 13, wherein the adjusting device is adjustable continuously.

25. The device according to claim 13, wherein the adjusting device is adjustable by indexing.

26. The device according to claim 13, wherein the adjusting device is adjustable manually.

27. The device according to claim 13, wherein the adjusting device is adjustable by servomotors.

28. The device according to claim 13, wherein the support shaft comprises a solid cylinder body on which the counter pressure cylinder is running.

29. The device according to claim 28, comprising a drive device with a gear secured on the solid cylinder body of the support shaft and configured to transmit torque to the counter pressure cylinder.

30. The device according to claim 13, wherein the punching cylinder is moveable relative to the support shaft when an adjustment is carried out by the adjusting device.
